(19) United States
(12) Patent Application Publication
(10) Pub. No.: US 2021/0047742 A1
(43) Pub. Date: Feb. 18, 2021

(54) METHOD OF MAKING ALKALI AND GYPSUM BY PROTON-COUPLED ELECTRON TRANSFER REACTION

(71) Applicants: Yufei WANG, Chongqing (CN); Tao LIU, Chongqing (CN)

(72) Inventors: Yufei WANG, Chongqing (CN); Tao LIU, Chongqing (CN)

(21) Appl. No.: 16/542,551

(22) Filed: Aug. 16, 2019

(51) Int. Cl. C25B 1/14; C25B 1/16

(52) U.S. Cl. CPC C25B 1/14; C25B 1/16

(57) ABSTRACT

The present disclosure provides a method for preparing an alkali and co-producing gypsum, and belongs to the technical field of chemical production. The method comprises the steps of placing a cation exchange membrane into an electrolytic cell, adding a solution of sodium salt of a weak acid and a compound MH to an anode region as an anode electrocatalyst, adding sodium carbonate or sodium hydroxide to a cathode region, adding a compound M as a cathode electrocatalyst, and applying a DC power supply between a cathode electrode and an anode electrode. The electrolysis oxidizes the MH into the M and releases H⁺, Na⁺ in the anolyte penetrates through the cation exchange membrane to reach a cathode region to be combined with OH⁻ in the catholyte to generate NaOH, or further absorbs CO₂ and converts into Na₂CO₃; the anolyte containing a large amount of H⁺ is generated by the electrolysis for dissolution reaction with limestone, and the H⁺ is consumed to generate Ca²⁺, and SO₄²⁻ and Ca²⁺ are combined to generate high-purity CaSO₄ precipitate. According to the present disclosure, a compound capable of generating PCET reaction is used as an electrocatalyst, while M is its oxidation state and MH is its reduction state, and mirabilite and limestone are used as raw materials to realize the preparation of soda ash, caustic soda and gypsum.

### TECHNICAL FIELD

The present disclosure belongs to the technical field of novel low-energy-consumption two-alkali chemical production, and particularly relates to a method for preparing two-alkali and co-producing high-purity gypsum from mirabilite and limestone by proton-coupled electron transfer (PCET) reaction.

### BACKGROUND ART

“Two-alkali” (soda ash and caustic soda) is one of the most important product in chemical industry, which is widely used in building, chemical, metallurgical, printing and dyeing, leather-making, daily chemical and food industry. China is the world's largest country in soda ash and caustic soda production. Statistically, in 2012, the total consumption of salt (sodium chloride) in the country was 86.6 million tons, while the proportion of salt used in the two-alkali industries exceeded 80%, reaching 70.75 million tons. At present, the annual soda ash output in China is close to 30 million tons, the annual caustic soda output is close to 40 million tons, with the annual output value exceeding 250 billion Chinese Yuan, and the global two-alkali output value exceeds 600 billion Chinese Yuan.

Soda ash is even called “mother of chemical industry,” and its output and consumption are usually regarded as one of the signs to measure the level of industrial development of a country. At present, Solvay process, which has a history of more than 140 years, is still the most important process for alkali production in the world nowadays. After hundreds of years of development and optimization, it has been applied in a large scale worldwide and obtained good economic benefits. People seem to lose confidence in the challenge of Solvay process. However, Solvay process still has the following difficulties: (1) low utilization rate of raw materials: the utilization rate of raw material sodium chloride is only 72%-74% due to process limitation, and a large amount of unreacted sodium chloride solution is discharged along with waste liquid, causing great raw material loss; (2) high production energy consumption: in China, the energy consumption per ton of soda ash is up to 15 GJ due to the high energy consumption of limestone calcination and ammonia cycle in the process of alkali production by the ammonia-soda process; however, the theoretical energy consumption for soda ash production is only 3.82 GJ, with great room for improvement; (3) high environmental protection pressure: due to the fact that a large amount of ammonia solution rich in calcium chloride and sodium chloride in low concentration is produced as by-products in the process, waste purification and utilization are difficult, with no economic benefits, so that most of the ammonia solution is directly discharged to the sea; 9-11 m³ waste liquid and waste residues, containing about 200-300 kg of solid residues, are discharged in every ton of soda ash production, which will bring great hidden dangers to safe production of enterprises.

Caustic soda is also widely used in the national economy, and is mainly prepared by an electrolysis method, that is, salt water is electrolyzed by an ion-exchange membrane method to prepare caustic soda, and chlorine gas is generated at the anode and hydrogen gas is generated at the cathode in the electrolysis process. The method has the advantages of rich raw material sources, and high utilization rate of raw materials, caustic soda quality and byproduct purity (H₂ and Cl₂ with purity >99%). However, the main problems in caustic soda production are as follows: (1) high electrolysis energy consumption: in the electrolysis process, the cathode and the anode are continuously generating hydrogen and chlorine gases, the theoretical potential is up to 2.172 V, and the electrolysis voltage is more than 3 V in the actual industrial production; the DC consumption is 2200 kWh per ton of NaOH produced, accounting for more than 80% of the total energy consumption in the caustic soda production; (2) high operational risk: liquid chlorine and chlorine gas belong to the first batch of dangerous chemicals which are emphatically supervised, and even under the strict supervision policy, the safety accidents caused by chlorine gas still emerge in endlessly; (3) high environmental protection pressure: chlorine gas, as a highly toxic gas, is the largest by-product of ion-exchange membrane caustic soda industry, with a by-product of 0.89 tons of chlorine gas per ton of caustic soda produced. Therefore, a plurality of environmental protection problems are brought: (1) 20 kg of waste sulfuric acid containing chlorine is produced from every ton of chlorine produced, dramatically increasing the operating cost for environmental protection; (2) the maximum allowable emission concentration limit value of chlorine-containing tail gas in chlor-alkali production is reduced from 65 mg/m³ to 5 mg/m³ by the newly issued “Chloride Emission Standard” in China in 2018, so that the operating cost for environmental protection is greatly improved; (3) in the long run, the chlorine gas downstream market cannot match chlorine gas production. In the past two years, the situation of giving away liquid chlorine free and subsidizing freight is common, and the strengthening of environmental protection management and control of liquid chlorine and the low market situation will seriously affect the profitability of chlor-alkali enterprises.

After hundreds of years of development and optimization, the production of two-alkali has been applied on a large scale in the world, and good economic benefits have been obtained. However, with the development of chemical technology, especially electrochemical technology, and the enhancement of human awareness of environmental protection, the economic and environmental problems, such as high energy consumption, emission, safety risk and so on, in the two-alkali manufacturing process become more and more prominent, which has seriously restricted the further development of the two-alkali industry.

Under the background of energy saving, emission reduction and environmental protection, the problems of high energy consumption, emission, safety risk and the like in the two-alkali manufacturing process are further enlarged. Based on the great role of two-alkali in national industry, the upgrading of two-alkali industry is very urgent, and it has great significance to develop energy-saving, environment-friendly and green novel two-alkali manufacturing technology.

### SUMMARY OF THE INVENTION

Aiming at the defects of the prior art, the present disclosure provides a method for preparing two-alkali and co-producing high-purity gypsum from mirabilite and limestone by a PCET reaction on the basis of an electrochemical technology, thoroughly solves the problems of high energy consumption, emission, safety risk and the like in the production of the two-alkali (soda ash and caustic soda), greatly reduces the manufacturing cost of the soda ash and caustic soda, and simultaneously realizes the efficient utilization of the mirabilite and limestone.

The objects of the present disclosure could be achieved by the following technical scheme:

In one aspect, the present disclosure provides a method for preparing an alkali comprising the steps of:

performing cation membrane exchange, wherein an anode region comprises weak acid radical ions and a compound MH capable of performing PCET reaction, a cathode region comprises a compound M capable of performing PCET reaction, the anode region and the cathode region comprise sodium ions, and the pH value of the cathode region is higher than that of the anode region; and

applying DC power supply between the anode electrode and the cathode electrode.

In one embodiment, the alkali is soda ash, and when the cation membrane exchange is performed, the anode region comprises a solution of sodium salt of a weak acid and a compound MH capable of performing PCET reaction, the cathode region comprises sodium carbonate and a compound M capable of performing PCET reaction, and the method further comprises introducing CO₂ into the cathode region.

Furthermore, the soda ash is sodium carbonate, and after applying the DC power supply, the method further comprises:

evaporating and crystallizing the liquid in the cathode region;

calcining monohydrate sodium carbonate; and

cooling the alkali.

In another embodiment, the alkali is caustic soda, and when the cation membrane exchange is performed, the anode region comprises a solution of sodium salt of a weak acid and a compound MH capable of performing PCET reaction, and the cathode region comprises a sodium hydroxide and a compound M capable of performing PCET reaction.

Furthermore, wherein, the alkali is a solid caustic soda flake, and after the applying the DC power supply, the method further comprises:

evaporating the liquid in the cathode region.

In one embodiment, the cation membrane exchange is performed by placing the cation exchange membrane into an electrolytic cell that is divided into the anode region and the cathode region.

In one aspect, the present disclosure also provides a method for preparing gypsum, comprising:

reacting the liquid in an anode region obtained after the alkali preparation with limestone;

performing mirabilite dissolving to mirabilite; and

mixing the solution obtained from the mirabilite dissolving with the solution obtained by reaction with the limestone.

In one embodiment, the reaction with the limestone is performed by simultaneously introducing the limestone and the liquid in the anode region into a dissolving agitator.

In one embodiment, the reaction with the limestone generates CO₂.

In one embodiment, after generation, the CO₂, via washing and compression procedures, is circulated to the cathode region for soda ash production, or for other uses.

In one embodiment, the mirabilite dissolving is performed by introducing the mirabilite into a salt dissolving tank to form a sodium sulfate solution.

In one embodiment, the solution obtained from the mirabilite dissolving is mixed with the solution obtained by reaction with the limestone as follows:

simultaneously introducing the solution obtained by reaction with limestone and the solution obtained from the mirabilite dissolving into a precipitation reactor to generate precipitates in the precipitation reactor; and

performing solid-liquid separation on the precipitates and the solution in the precipitation reactor;

wherein the solution subjected to solid-liquid separation is a solution of a sodium salt of a weak acid;

wherein the precipitates are solid precipitates of calcium sulfate.

In one embodiment, the solution subjected to solid-liquid separation is refined by brine and then introduced into an electrolytic cell, and the precipitates are dried to remove water.

In one embodiment, the precipitates are washed and dried at 50-150° C. to remove water, preferably oven dried at 100-150° C.

In one aspect, the present disclosure also provides a method for preparing an alkali and gypsum, the method comprising:

firstly preparing the alkali by adopting said method for preparing the alkali; and

then preparing the gypsum by adopting said method for preparing the gypsum.

wherein the alkali is soda ash or caustic soda.

In one embodiment, the method for preparing an alkali and gypsum specifically comprises the steps of:

preparing the alkali:

performing cation membrane exchange, wherein an anode region comprises weak acid radical ions and a compound MH capable of performing PCET reaction, a cathode region comprises a compound M capable of performing PCET reaction, the anode region and the cathode region comprise sodium ions, and the pH value of the cathode region is higher than that of the anode region; and

applying a DC power supply between the anode electrode and the cathode electrode.

wherein the alkali is soda ash, and when the cation membrane exchange is performed, the anode region comprises a solution of sodium salt of a weak acid and a compound MH capable of performing PCET reaction, the cathode region comprises sodium carbonate and a compound M capable of performing PCET reaction, and the method further comprises introducing CO₂ into the cathode region; or

the alkali is caustic soda, and when the cation membrane exchange is performed, the anode region comprises a solution of sodium salt of a weak acid and a compound MH capable of performing PCET reaction, and the cathode region comprises sodium hydroxide and a compound M capable of performing PCET reaction;

preparing the gypsum:

reacting the liquid in an anode region obtained after the alkali preparation with limestone;

performing mirabilite dissolving to the mirabilite; and

mixing the solution obtained from the mirabilite dissolving with the solution obtained by reaction with the limestone to prepare the limestone.

In some embodiments, the limestone is added in such an amount that the molar ratio of CaCO₃ to weak acid in the anolyte is 1:2-1:0.5.

In a more specific embodiment, the method for preparing alkali and gypsum is specifically a method for preparing two-alkali and co-producing high-purity gypsum from mirabilite and limestone by the PCET reaction, wherein the method comprises placing a cation exchange membrane into an electrolytic cell to divide the electrolytic cell into an anode region and a cathode region, adding a solution of sodium salt of a weak acid into the anode region as an anolyte, and adding sodium carbonate or sodium hydroxide into the cathode region as a catholyte; meanwhile, adding a compound M capable of performing PCET reaction into a cathode region as a cathode electrocatalyst, adding a compound MH capable of performing PCET reaction into an anode region as an anode electrocatalyst, and applying a DC power supply between an anode electrode and a cathode electrode;

Under the action of current, when producing soda ash, CO₂ introduced into a cathode region is ionized into H⁺ and CO₃²⁻, the H⁺ is combined with an electrocatalyst M at a cathode electrode to form an MH, and a CO₃²⁻ rich solution is formed in the catholyte; when producing caustic soda, M in the catholyte is combined with H⁺ ionized by water to generate MH, and an OH⁻ rich solution is formed in the catholyte; meanwhile, MH in the anode region is oxidized to M at the anode electrode, and H⁺ is released, so that an acidic solution rich in H⁺ is formed in the anolyte;

presetting a solution of sodium salt of a weak acid into an anode region to generate a large amount of weak acid solution, simultaneously enabling Na⁺ to penetrate through a cation exchange membrane to reach a cathode region to be combined with OH⁻ or CO₃²⁻ to generate a NaOH solution or a Na₂CO₃ solution, and further evaporating and crystallizing to obtain solid caustic soda or soda ash;

The process for preparing high-purity gypsum from anolyte while regenerating a solution of sodium salt of a weak acid comprises the steps of dissolving and precipitating:

(1) dissolution process: the anolyte containing a large amount of weak acid and limestone undergo a dissolution reaction, and Ca²⁺ is generated while H⁺ is continuously consumed, realizing rapid dissolution of CaCO₃; and

(2) precipitation process: Ca²⁺ generated after limestone dissolution is combined with SO₄²⁻ from the mirabilite dissolving to generate high-purity CaSO₄ precipitate, Na⁺ in the mirabilite is combined with weak acid radical ions in an anolyte to regenerate sodium salt of a weak acid circulated to the anode region, and when the product is soda ash, CO₂ released in the dissolution process is circulated to a cathode region for soda ash production.

Further, the mirabilite dissolving is performed by introducing the mirabilite into a dissolving vessel for salt dissolving to obtain a sodium sulfate solution to participate in a reaction.

Further, the limestone and the anode weak acid solution generated by electrolysis are simultaneously introduced into a dissolving agitator to carry out acid dissolution reaction of the limestone, and CO₂ generated by dissolution is subjected to washing and compression procedures for soda ash production or other uses.

Further, the calcium-rich solution generated by the acid dissolution reaction of the limestone and the sodium sulfate solution obtained from the mirabilite dissolving are simultaneously introduced into a precipitation reactor, calcium sulfate solid is generated in the precipitation reactor, solid-liquid separation is further performed on the generated calcium sulfate precipitates and the sodium salt solution of the weak acid, the regenerated solution of sodium salt of the weak acid is refined by brine and introduced into an electrolytic cell for continuous reaction, and the calcium sulfate precipitates are dried and dewatered as a by-product.

Further, the sodium carbonate solution generated in the cathode region is further subjected to evaporation and crystallization, monohydrate sodium carbonate calcination and alkali cooling to be converted to a heavy sodium carbonate product.

Further, the sodium hydroxide liquid generated in the cathode region can be directly used as a caustic soda liquid product or can be further converted into a solid caustic soda flake product through evaporation.

Further, the solution of sodium salt of the weak acid is selected from the group consisting of sodium acetate, sodium formate, sodium oxalate, sodium citrate, sodium borate or sodium lactate.

Further, the PCET reaction is proton-coupled electron transfer, and the specific reaction chemical formula is as follows:

MHₙ→M+nH⁺+ne or M+nH⁺+ne→MHₙ.

Further, the compounds MH and M are compounds capable of undergoing a PCET reaction, M is in its oxidation state, and MH is in its reduction state.

In some embodiments, a compound M is an aromatic compound or a compound with free radicals.

In some embodiments, the compound M is an aromatic compound comprising a carbonyl group or a heterocycle; the carbon atom of the carbonyl group is positioned on the aromatic ring of the aromatic compound; or the heteroatom of the heterocycle is nitrogen; or the compound comprises a plurality of heterocycles.

In some embodiments, the compound M is a fused ring compound comprising at least a structure of Formula (A),

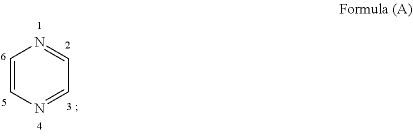

In some embodiments, the carbon atoms at positions 2 and 3 of the structure of Formula (A) are forming a common edge of the structure of Formula (A) and another aromatic ring.

In some embodiments, the fused ring comprises at least a structure of Formula (B),

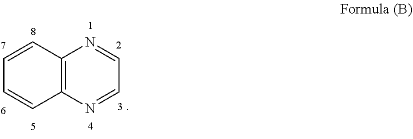

In some embodiments, the carbon atoms at positions 2 and 3 of the structure of Formula (B) are forming a common edge of the structure of Formula (B) and another aromatic ring.

In some embodiments, the fused ring comprises at least two structures of Formula (B);

In some embodiments, the carbon atoms at positions 2 and 3 of the two structures of Formula (B) are forming a common edge of the two structures of Formula (B), or common edges of the two structures of Formula (B) and another aromatic ring respectively.

In some embodiments, the fused ring comprises at least a structure of Formula (C) or a structure of Formula (D),

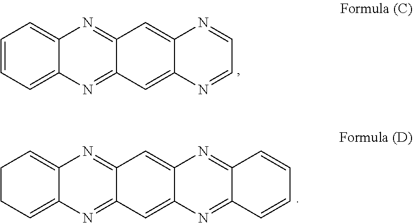 [SMILES: c1ccc2nc3cc4nccnc4cc3nc2c1 ; C1=c2nc3cc4nc5ccccc5nc4cc3nc2=CCC1]

In some embodiments, the compound M comprises at least a structure of Formula (E),

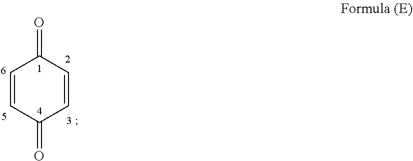

In some embodiments, the carbon atoms at positions 2 and 3 of the structure of Formula (E) are forming a common edge of the structure of Formula (E) and another aromatic ring.

In some embodiments, the carbon atoms at positions 2 and 3 of the structure of Formula (E) are the common edges of the structure of Formula (E) and the another aromatic ring, and the carbon atoms at positions 5 and 6 of the structure of Formula (E) are forming a common edge of the structure of Formula (E) and yet another aromatic ring.

In some embodiments, wherein the compound M comprises at least a structure of Formula (F),

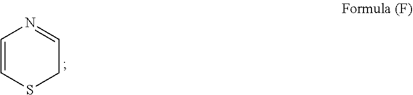

In some embodiments, the compound M is a fused ring compound and the aromatic ring is a part of the fused ring.

In some embodiments, the compound M comprises at least a structure of Formula (G),

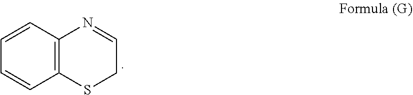

In some embodiments, the chemical structure of M in an oxidation state may be preferably, but is not limited to, the following chemical structures:

| # | Chemical structural formulas |
|---|---|
| 1 | 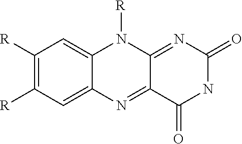 |
| 2 | 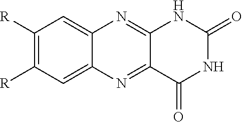 |
| 3 | 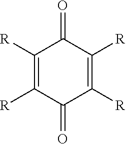 |
| 4 | 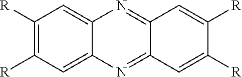 |
| 5 | 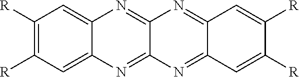 |
| 6 | 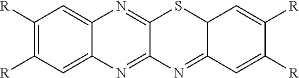 |
| 7 | 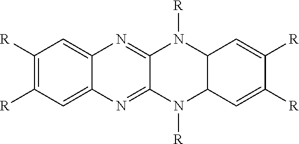 |
| 8 | 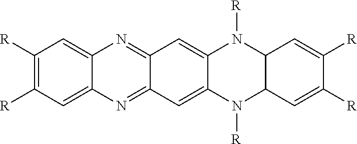 |
| 9 | 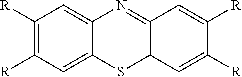 |
| 10 | 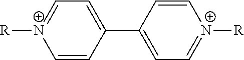 |
| 11 | 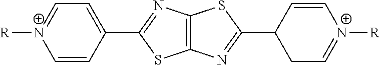 |
| 12 | 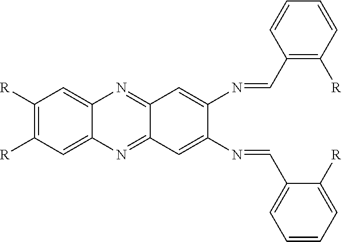 |
| 13 | 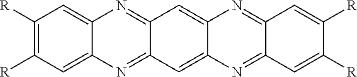 |

wherein any group R is independently selected from H, methyl, ethyl, hydroxy, sulfo, carboxy, PEG group, imidazolyl, amino, Cl⁻ or Br⁻.

In some embodiments, the M is

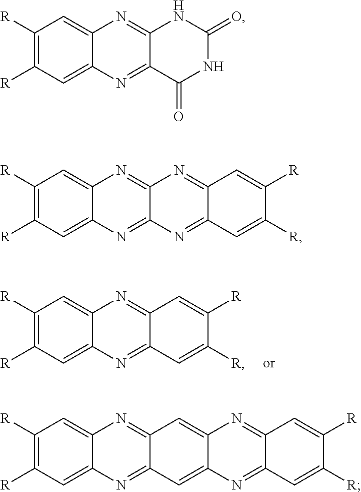

wherein any group R is independently selected from H, methyl, ethyl, hydroxy, sulfo, carboxy, PEG group, imidazolyl, amino, chlorine group, or bromine group.

In some embodiments, the M is

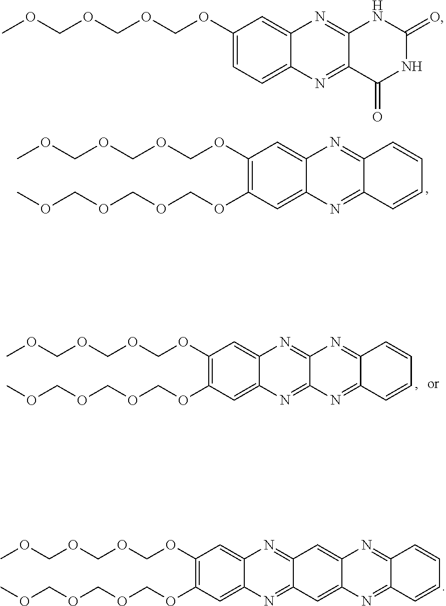

Further, when the oxidation-state electrocatalyst MH in the anode region reacts to generate a reduction-state electrocatalyst M, and the M in the cathode region reacts to generate an MH, performing “extraction-reverse extraction” by one or more of dichloromethane, chloroform, carbon tetrachloride, ethyl acetate, kerosene, ionic liquid methylimidazolium hexafluorophosphate, trioctylphosphine oxide and petroleum ether, or performing the cathode and anode electrocatalyst exchange by a dialysis membrane or a nanofiltration membrane interception treatment, so as to maintain the continuous and stable progress of the electrochemical reaction.

In some embodiments, the anode electrode and the cathode electrode are both carbon material electrodes, or porous electrodes and three-dimensional structured electrodes made of a carbon material.

In some embodiments, the carbon material electrode is one or more of graphite felt, carbon felt, carbon paper, and carbon cloth, or one or more of graphite felt, carbon felt, carbon paper, and carbon cloth doped with an active material.

In some embodiments, the present disclosure employs a compound having the properties of a PCET reaction as an electrocatalyst, which is used to drive the hydro-ionization decomposition (H₂O→H⁺+OH⁻) at ultra-low voltage by the redox reaction occurring at the electrode, and the generated H⁺ is used to accelerate the dissolution of limestone. The generated OH⁻ absorbs CO₂ for producing soda ash and caustic soda, meanwhile, and Ca²⁺ after limestone acid dissolution reacts with SO₄²⁻ in mirabilite to generate high-purity CaSO₄ solid precipitates, so that no three wastes are generated in the process of preparing soda ash, caustic soda and gypsum.

Compared with the prior art, a technical solution of the technical solutions in the present disclosure has the following beneficial effects.

1. Greatly Reducing the Manufacturing Energy Consumption and Cost of the Two-Alkali (Soda Ash and Caustic Soda)

Compared with the existing industrial large-scale electrolysis method, the present disclosure utilizes the compound with the PCET reaction ability as an electrocatalyst, and replaces the H₂O decomposition reaction (2H₂O→O₂+4H⁺+4e) in the traditional electrolysis method by the hydrogen atom oxidation reaction (MH→M+H⁺+e). The unit electrolysis voltage in the prior art is reduced from 3V to less than 1V by more than 66%, so that the energy consumption in the production of the two-alkali is greatly reduced.

Simultaneously, compared with a novel low-energy-consumption ion membrane electrolysis technology which is widely researched at present and uses hydrogen as an induction medium, the cathode hydrogen evolution reaction (HER) (H₂O+2e→H₂+OH⁻) and the anode hydrogen oxidation reaction (HOR) (H₂→2H⁺+2e) both require high overpotential and noble metal platinum and the like as catalysts, while in the present disclosure, the “H-catalyst” intermediate state substance is formed at a low potential by the PCET catalyst with hydrogen atom absorption and transfer used as a medium, reducing the overpotential of the electrode reaction, so that the energy consumption of the electrolysis reaction is further reduced, the noble metals Pt, Pd and the like are replaced by cheap organic catalysts, substantially lowering the manufacturing cost of the electrolytic cell, and therefore the high energy consumption and the high cost of the electrolysis process are broken through in principle. Meanwhile, as the hydrogen is used as an inflammable and explosive substance, the present disclosure effectively avoids the generation and circulation of the hydrogen and further improves the feasibility and the safety of the technology, which is more suitable for practical popularization and application.

2. Thoroughly Solving the Environmental Protection Problem in the Production Process of the Two-Alkali

According to the present disclosure, the PCET chemical reaction is applied to the two-alkali manufacturing processes to thoroughly solve the possibility of high-risk chlorine gas generation in principle, so that the high-safety risk problem of caustic soda production is solved, the discharge problem of chlorine-containing waste sulfuric acid in the caustic soda production is solved, and the discharge problem of chlorine-containing tail gas in the caustic soda production is thoroughly solved. Meanwhile, according to the production path for preparing the two-alkali from the mirabilite (or aqueous glauber salt) and the limestone provided by the present disclosure, the gypsum material with high purity (the purity is more than 99%) and high added value can be co-produced at the same time, so that the discharge problem of a large amount of calcium chloride waste liquid in the process of producing the soda ash by using the sodium chloride in the traditional process is thoroughly solved.

3. Efficient Utilization of Mirabilite Resources

The mirabilite mineral resources in China are very rich, with the mirabilite reserves more than 117 billion tons, ranked first in the world and more than the sum of other countries in the world. The present disclosure will effectively utilize the mirabilite resources with huge reserves and limited utilization ways in China and industrial by-product mirabilite resources.

4. Further Improving the Purity of the Product

In the traditional process, a large amount of unreacted sodium chloride is contained in the prepared alkali, so that the purification is very difficult, and the purity of the superior alkali is only about 99.4%. The ionic membrane alkali preparation technology avoids the contact between a product and a raw material, the content of other impurities in the alkali is greatly reduced, the product characteristics are more stable, the purity of the product alkali reaches more than 99.7%, and the purity of gypsum reaches more than 99%.

### BRIEF DESCRIPTION OF THE DRAWINGS

FIG. 1 is a schematic diagram showing the principle for preparing two-alkali and co-producing high-purity gypsum from mirabilite and limestone by a PCET reaction.

FIG. 2 shows the effect of different acid radical ions on current efficiency.

FIG. 3 shows the relationship of different HAc/CaCO₃ ratios versus Ca²⁺ leaching rate and final CaCO₃ conversion rate.

FIG. 4 shows changing situations of the current density with the voltage at different temperatures.

FIG. 5 is an XRD result of the calcium sulfate product of Example 1.

FIG. 6 is a thermogravimetric analysis result of the solid product Na₂CO₃ in Example 1.

### DETAILED DESCRIPTION OF THE INVENTION

In order that the objects, technical solutions, and advantages of the present disclosure will become more apparent, the present disclosure will be described in further detail with reference to examples. It should be understood that the specific examples described herein are merely illustrative of the present disclosure and are not intended to be limiting thereof.

It should be noted that “selected from the following group” or “selected from the group consisting of” in the present disclosure includes any one of the groups as well as any plurality ones of the groups.

The method for preparing two-alkali and co-producing high-purity gypsum from mirabilite and limestone by a PCET reaction according to the present disclosure is described in detail with reference to specific principles.

In a large number of redox reactions (such as photosynthesis, respiration and so on) in the natural world, the transfer of electrons is often accompanied by the synchronous transfer of protons, i.e. a phenomenon known as Proton-Coupled Electron Transfer (PCET). According to the present disclosure, the PCET reaction is successfully applied to chemical production to provide a production technology of soda ash and caustic soda with low-energy-consumption electrochemistry.

To simplify understanding and to provide a more direct reference to the scope of the present disclosure, processes that occur substantially similar to the following reaction (Reaction 1) may be referred to as PCET reaction processes within the scope of this patent.

MHₙ→M+nH⁺+ne or M+nH⁺+ne→MHₙ (1)

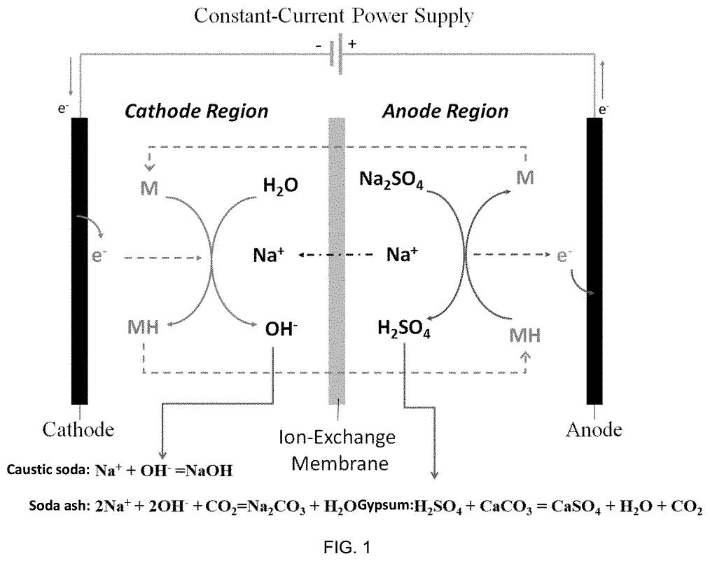

FIG. 1 is a schematic diagram showing a principle for preparing two-alkali and co-producing high-purity gypsum from mirabilite and limestone by a PCET reaction according to the present disclosure. During a particular reaction, H⁺ and OH⁻ are formed at the anode and cathode, respectively, of the membrane electrolysis reactor. The membrane electrolytic cell consists of an anode electrode, a cathode electrode and a layer of cation exchange membrane dividing the container into an anode region and a cathode region. Before the reaction is started, a solution of sodium salt of a weak acid is added to an anode region as an anolyte, and sodium carbonate or sodium hydroxide is added to a cathode region as a catholyte (a sodium carbonate solution is adopted when producing soda ash, and a sodium hydroxide solution is adopted when producing caustic soda); meanwhile, a compound M is added to a cathode region as a cathode electrocatalyst, and a compound MH is added to an anode region as an anode electrocatalyst (wherein M and MH generally refer to all compounds capable of performing PCET reaction), realizing ionization reaction of water (H₂O→H⁺+OH⁻) at a low potential, avoiding high overpotential of HER and HOR reaction on an electrode, thereby greatly improving membrane electrolysis reaction performance; meanwhile, noble metal Pt is not needed as a catalyst, and the manufacturing cost of the electrolytic cell is greatly reduced.

Under the action of current, when soda ash is produced, CO₂ introduced into a cathode region is ionized into H⁺ and CO₃²⁻, the H⁺ at a cathode electrode is combined with an electrocatalyst M to form an MH, and a CO₃²⁻ rich solution is formed in the catholyte; when caustic soda is produced, M in the catholyte is combined with H⁺ ionized by water to generate an MH, and an OH⁻ rich solution is formed in the catholyte; meanwhile, the MH in the anode region is oxidized to a M at the anode electrode, and H⁺ is released, so that an acidic solution rich in H⁺ is formed in the anolyte; the electrode reaction is as follows:

Anode: MH→H⁺+M+e (1)

Cathode: CO₂+H₂O+2 M+2e→CO₃²⁻+2MH (2)

H₂O+M+e→OH⁻+MH (3)

Presetting a sodium salt solution of a weak acid into an anode region to generate a large amount of weak acid solution, simultaneously enabling Na⁺ to penetrate through a cation exchange membrane to reach a cathode region to be combined with OH⁻ or CO₃²⁻ to generate a NaOH solution or a Na₂CO₃ solution, and further evaporating and crystallizing to obtain solid caustic soda or soda ash;

The process for preparing high-purity gypsum from anolyte while regenerating a solution of sodium salt of a weak acid comprises the steps of dissolving and precipitating:

(1) Dissolution process: the anolyte containing a large amount of weak acid and limestone undergo a dissolution reaction, and Ca²⁺ is generated while H⁺ is continuously consumed, realizing rapid dissolution of CaCO₃;

(2) Precipitation process: Ca²⁺ generated after limestone dissolution is combined with SO₄²⁻ from the mirabilite dissolving to generate high-purity CaSO₄ precipitates, Na⁺ in the mirabilite is combined with weak acid radical ions in an anolyte to regenerate sodium salt of a weak acid circulated to the anode region, and when the product is soda ash, CO₂ released in the dissolution process is circulated to a cathode region for soda ash production. The reaction of the dissolution and precipitation process is as follows:

Dissolution: 2H⁺+CaCO₃→Ca²⁺+CO₂+H₂O (4)

Precipitation: Ca²⁺+Na₂SO₄→CaSO₄+2Na⁺ (5)

Further, the mirabilite dissolving is performed by introducing the mirabilite into a dissolving vessel for salt dissolving to obtain a sodium sulfate solution to participate in a reaction.

Further, the limestone and the anode weak acid solution generated by electrolysis are simultaneously introduced into a dissolving agitator to carry out acid dissolution reaction of the limestone, and CO₂ generated by dissolution is subjected to washing and compression procedures for soda ash production or other uses.

Further, the calcium-rich solution generated by the acid dissolution reaction of the limestone and the sodium sulfate solution obtained from the mirabilite dissolving are simultaneously introduced into a precipitation reactor, calcium sulfate solid is generated in the precipitation reactor, solid-liquid separation is further performed on the generated calcium sulfate precipitates and the solution of sodium salt of the weak acid, the regenerated solution of sodium salt of the weak acid is refined by brine and introduced into an electrolytic cell for continuous reaction, and the calcium sulfate precipitates are dried and dewatered as a by-product.

Further, the sodium carbonate solution generated in the cathode region is further subjected to evaporation and crystallization, monohydrate sodium carbonate calcination and alkali cooling to be converted to a heavy sodium carbonate product.

Further, the sodium hydroxide liquid generated in the cathode region can be directly used as a caustic soda liquid product or can be further converted into a solid caustic soda flake product through evaporation.

Further, a solution of sodium salt of a weak acid is one or more of sodium acetate, sodium formate, sodium oxalate, sodium citrate, sodium borate, and sodium lactate. According to the present disclosure, the reason and the effect of selecting the salt of the weak acid as the anolyte are as follows:

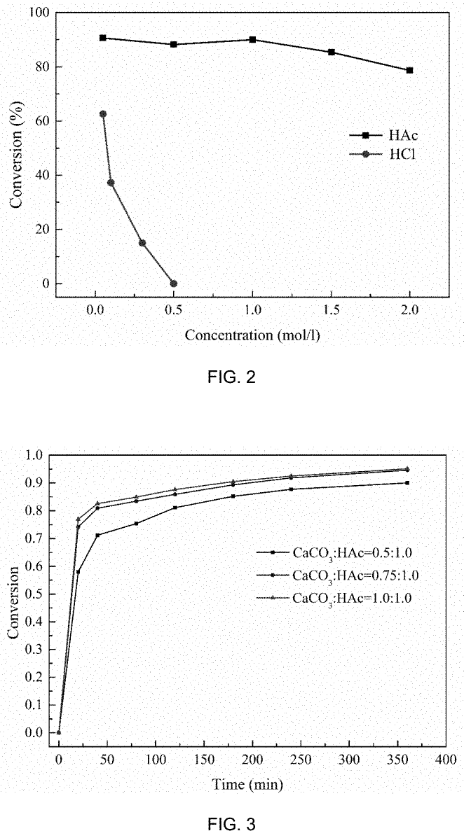

According to the present disclosure, the ionization balance of water is broken by the electrochemical PCET reaction, and the H⁺ enriched in the anode region needs to be matched with acid radical ions to maintain the charge balance of the reaction. FIG. 2 shows the effect of different acid radical ions on current efficiency. As can be seen from FIG. 2, when Cl⁻ is introduced to generate HCl as a target product, even if the initial HCl is only 0.05 M, the current efficiency measured after 1 hour is as low as 62.59%; when the HCl concentration is increased to 0.5 M, the current efficiency of the electrolysis process is only 0.02%. When Ac⁻ is introduced to generate HAc as a target product, the current efficiency of electrolysis process is not significantly affected by the increase of acid concentration; when the concentration of HAc is increased to 2 M, the decrease of current efficiency could be clearly observed, but the current efficiency could still reach 78.65%. This is because all cations on the anode side (H⁺, Na⁺) have an opportunity to penetrate through the cation exchange membrane to the cathode region during electrolysis. The strong acid such as HCl can be completely ionized in the aqueous solution, and the H⁺ thereof reaches the cathode region for neutralization reaction with an alkaline solution in the cathode, so that the current efficiency is reduced. However, as a weak acid, HAc is formed by combining the H⁺ generated by the electrode reaction with Ac⁻ to form HAc, so that the H⁺ concentration in the anolyte is far less than that of Na⁺, which is also the basic reason why Ac⁻ has the effect of enhancing the current efficiency. Therefore, a weak acid, such as acetic acid, formic acid, citric acid, lactic acid and the like, is adopted as an intermediate medium, and then a solution of sodium salt of the weak acid is selected as an anolyte.

Further, as the reaction proceeds, the anolyte undergoes a process of continuously converting from a weak acid salt (hereinafter referred to as NaAc) to a mixture of a weak acid salt and a weak acid (hereinafter referred to as NaAc, HAc), and finally completely converting to a weak acid. As continuing forming of HAc, the electrolytic performance gradually decreases. This is because, as the electrolytic process proceeds, the concentration of NaAc continuously decreases, and the generated HAc belongs to a weak electrolyte, so the ionic conductivity of the solution continuously decreases; when the electrolyte is HAc completely, the solution hardly conducts electricity, and the internal resistance of the electrolytic cell significantly increases. Therefore, a weak acid salt solution with high concentration is served as an anolyte (such as, 2 M NaAc), a mixed solution of the weak acid salt and the weak acid (such as 1 M NaAc+1 M HAc) is taken out of the cell, and high-efficiency reaction of the cell is maintained while wide-range fluctuation of cell performance is avoided.

In order to maintain the high solution conductivity of the catholyte and simplify the process flow of subsequent product extraction and preparation, when producing soda ash, a certain concentration of Na₂CO₃ is selected as the catholyte, and CO₂ is quantitatively introduced in the electrolysis process; along with the progress of the electrolysis reaction, the Na₂CO₃ in the catholyte is continuously increased; after the high-concentration of Na₂CO₃ solution is discharged out of the electrolytic cell, the obtained solution only contains Na₂CO₃, and subsequently solid soda ash with extremely high purity can be easily prepared only by simple evaporation and concentration. In the same way, when caustic soda is produced, NaOH with a certain concentration is preferably used as a catholyte, the NaOH in the catholyte is continuously accumulated along with the progress of an electrolysis reaction, and then high-purity caustic soda can be easily prepared only through traditional chemical processes such as evaporation, crystallization and the like after being discharged from an electrolytic cell. If a certain concentration of NaCl is used as a catholyte, Na₂CO₃ or NaOH obtained by the cathode can form a mixed solution with NaCl, and the subsequent separation and purification processes are very troublesome, which is difficult to guarantee the purity of soda ash and caustic soda.

Further, the compounds M and MH are compounds capable of performing PCET reaction, M is in its oxidation state, and MH is in its reduction state; and the chemical structure of oxidation state M may preferably be, but is not limited to, the following chemical structures:

| # | Chemical structural formulas |
|---|---|
| 1 | 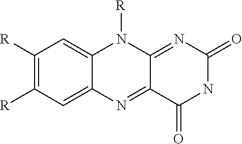 |
| 2 | 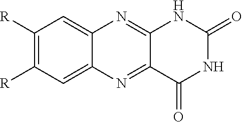 |
| 3 | 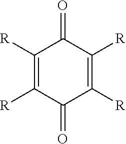 |
| 4 | 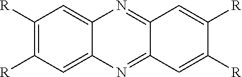 |
| 5 | 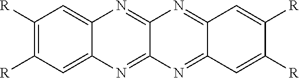 |
| 6 | 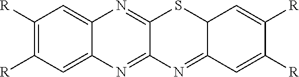 |
| 7 | 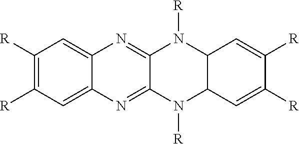 |
| 8 | 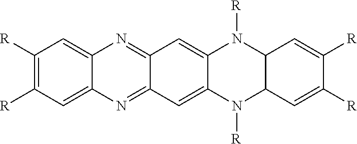 |
| 9 | 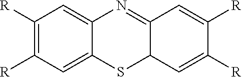 |
| 10 | 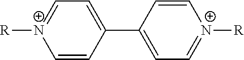 |
| 11 | 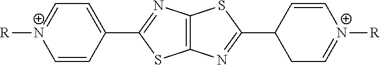 |
| 12 | 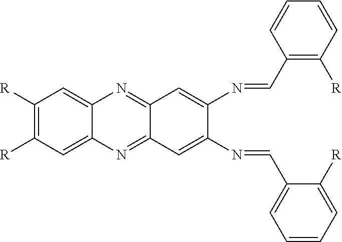 |
| 13 | 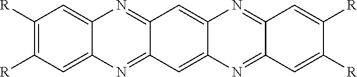 |

where R refers to any group that may be present; in some embodiments, any R group may be independently such as, but not limited to, H, methyl, ethyl, hydroxyl, sulfo, carboxyl, PEG group, imidazolyl, amino, chlorine group (Cl⁻) or bromine group (Br⁻), and the like.

In some embodiments, M is

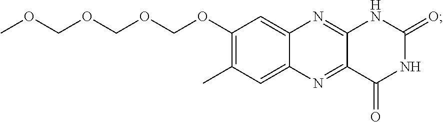 [SMILES: COCOCOCOc1cc2nc3[nH]c(=O)[nH]c(=O)c3nc2cc1C]

MH is

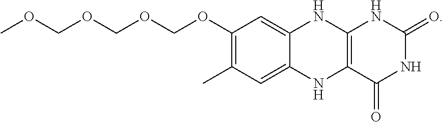 [SMILES: COCOCOCOc1cc2c(cc1C)Nc1c([nH]c(=O)[nH]c1=O)N2]

In some embodiments, M is

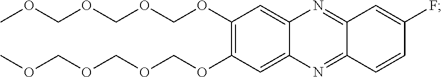 [SMILES: COCOCOCOc1cc2nc3ccc(F)cc3nc2cc1OCOCOCOC]

MH is

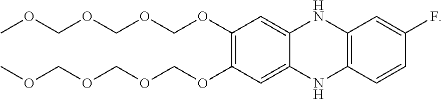 [SMILES: COCOCOCOc1cc2c(cc1OCOCOCOC)Nc1cc(F)ccc1N2]

In some embodiments, M is

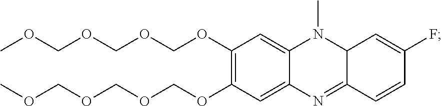 [SMILES: COCOCOCOc1cc2c(cc1OCOCOCOC)N(C)C1C=C(F)C=CC1=N2]

MH is

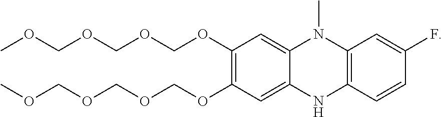 [SMILES: COCOCOCOc1cc2c(cc1OCOCOCOC)N(C)c1cc(F)ccc1N2]

In some embodiments, M is

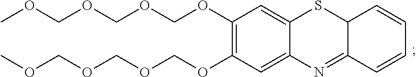 [SMILES: COCOCOCOc1cc2c(cc1OCOCOCOC)SC1C=CC=CC1=N2]

MH is

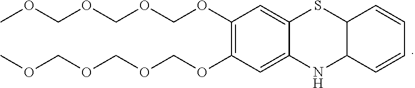 [SMILES: COCOCOCOc1cc2c(cc1OCOCOCOC)SC1C=CC=CC1N2]

In some embodiments, M is

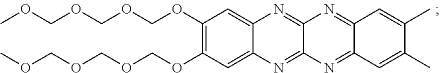

MH is

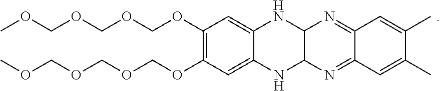

In some embodiments, M is

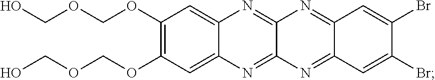 [SMILES: OCOCOc1cc2nc3nc4cc(Br)c(Br)cc4nc3nc2cc1OCOCO]

MH is

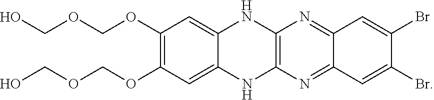 [SMILES: OCOCOc1cc2c(cc1OCOCO)Nc1nc3cc(Br)c(Br)cc3nc1N2]

In some embodiments, M is

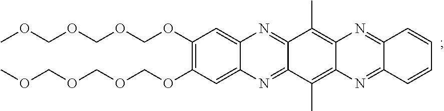 [SMILES: COCOCOCOc1cc2nc3c(C)c4nc5ccccc5nc4c(C)c3nc2cc1OCOCOCOC]

MH is

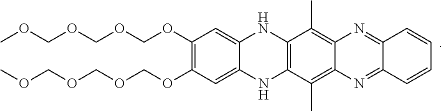 [SMILES: COCOCOCOc1cc2c(cc1OCOCOCOC)Nc1c(c(C)c3nc4ccccc4nc3c1C)N2]

According to the present disclosure, a substance capable of performing PCET reaction is used as a catalytic medium, and under the action of electric current, a redox reaction (MHn→M+nH⁺+ne, M+nH⁺+ne→MHn) with the catalytic medium replaces a decomposition reaction (2H₂O→O₂+4H⁺+4e, 2H₂O+2e→H₂+2OH⁻) of H₂O in a traditional electrolysis method. It is well known that electrolysis of water (oxygen evolution reaction) requires higher electrolysis voltage and noble metals as catalysts, and therefore energy consumption costs are higher. According to the present disclosure, compounds capable of performing PCET reaction are introduced into an electrolysis system, the PCET reaction is used for replacing the oxygen evolution reaction generated on the traditional electrode, so that the electrolysis voltage is greatly reduced, the noble metal Pt is not needed as a catalyst, and the manufacturing cost is greatly reduced. Meanwhile, because the organic matters mainly contain rich elements such as C, H, O and N, the raw materials are wide in source and low in price. Also, organic matters can change the properties of solubility, redox potential, steric hindrance and the like by connecting functional groups, so as to change the electrolysis rate, effect and stability.

In some embodiments, after an oxidation-state electrocatalyst MH in the anode region reacts to generate a reduction-state electrocatalyst M and an M in the cathode region reacts to generate an MH, “extraction-reverse extraction” is performed by an organic solvent or exchange of the cathode and anode electrocatalyst is performed by a dialysis membrane and/or nanofiltration membrane interception to maintain a sustained and stable electrochemical reaction.

In some embodiments, the organic solvent includes, but is not limited to, being selected from the group consisting of dichloromethane, chloroform, carbon tetrachloride, ethyl acetate, kerosene, ionic liquid methylimidazolium hexafluorophosphate, trioctylphosphine oxide or petroleum ether.

In some embodiments, the anode and cathode electrodes are carbon material electrodes, or porous electrodes and three-dimensional structured electrodes made of a carbon material. Further, the carbon material electrode is one or more of graphite felt, carbon felt, carbon paper, and carbon cloth, or one or more of graphite felt, carbon felt, carbon paper, and carbon cloth doped with an active material.

In some embodiments, the limestone is added in an amount of a molar ratio 1:2-1:0.5 of CaCO₃ to a weak acid in the solution. With the increase of CaCO₃ reactant, the consumption of H⁺ produced in electrolysis process is more complete in theory, which indirectly improves the reaction efficiency of the electrolysis process. The inventor has studied the molar ratio relationship between a weak acid (hereinafter referred to as HAc) and calcium carbonate. FIG. 3 shows the relationship of different HAc/CaCO₃ ratios versus Ca²⁺ leaching rate and final CaCO₃ conversion rate. As can be seen, the higher the CaCO₃ fraction is, the higher the reaction rate and the final conversion rate are. The reaction rate is faster in the first 50 minutes, and gradually slowed down with the increase of time, because acetic acid was a weak electrolyte and could not be completely dissociated in water. As H⁺ is continuously consumed, HAc is converted to Ac⁻, and the accumulation of Ac⁻ in the solution inhibits the further dissociation of acetic acid and prevents the further dissolution of CaCO₃. Thus, both a decrease in acetic acid concentration and an increase in calcium acetate concentration will decrease the efficiency of CaCO₃ dissolution. In the experiment, when the mole ratio of HAc/CaCO₃ is 1:0.75, the HAc conversion rate can reach 95.1% after 6 hours of dissolution, the influence of further increasing the proportion of CaCO₃ on the HAc conversion rate is not significant, and the mole ratio of CaCO₃ to the weak acid in the solution is 1:2-1:0.5.

In the present disclosure, Ca(Ac)₂ generated in the dissolution process is further reacted with a sodium sulfate solution to prepare high-purity gypsum, and meanwhile, the electrolytic raw material NaAc is regenerated; considering that the solubility of Na₂SO₄ is limited (1.27 M at 20° C.), the experimental addition of 1 M Na₂SO₄ is reasonable. With the increase of the ratio of Na₂SO₄, the content of Ca²⁺ in the solution is continuously decreased. When the proportion of Na₂SO₄/Ca(Ac)₂=1/1.5, the concentration of Ca²⁺ is no longer decreased significantly, and now the precipitation rate of Ca²⁺ reaches 91.27%. The experiment proves that the addition amount of mirabilite can significantly affect the conversion rate of the reaction, and the preferred ratio is 1:1.5.

Further, the CaSO₄ precipitates obtained in the anode region are washed and dried at 50-150° C. to obtain a high-purity gypsum product.

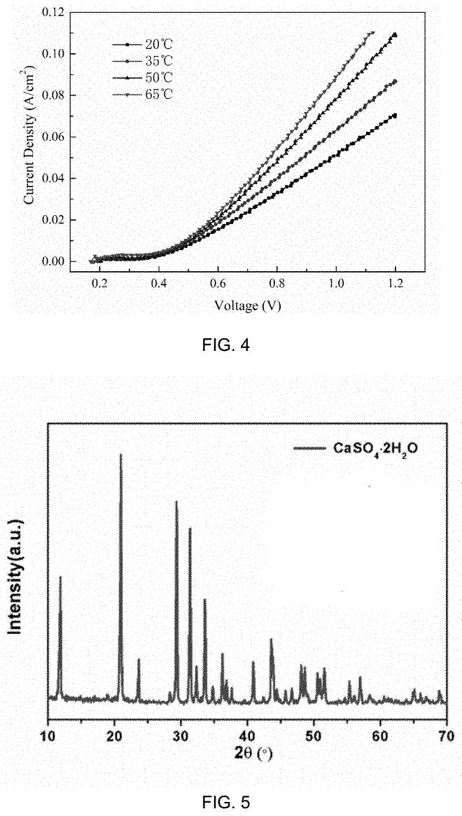

The reaction rate of the electrochemical reaction can be significantly affected by the temperature. Theoretically, the rate of the electrochemical reaction can be increased by 2 times for every 10° C. increase in temperature. FIG. 4 shows changing situations of the current density with the voltage at different temperatures when the anolyte is a mixture of 1 M HAc+1 M NaAc and the catholyte contains 1 M Na₂CO₃. As can be seen from FIG. 4, as the temperature increases, the electrolytic performance also increases. Therefore, maintaining a higher electrolysis reaction temperature will facilitate the rapid progress of the electrolysis reaction. However, too high a temperature causes an increase in process energy consumption and a decrease in stability of the electrocatalyst and the ion-exchange membrane, and therefore the present disclosure prefers an electrolysis temperature of 40-90° C.

According to the present disclosure, the concentration of the electrolyte and the concentration of the electrocatalyst can be regulated and controlled according to actual conditions, only the electrolysis effect is influenced, but the principle influence on whether the present disclosure can be successfully implemented or not is not influenced. Theoretically, higher electrolyte concentrations and electrocatalyst concentrations result in better electrolysis results.

The method for preparing two-alkali and co-producing high-purity gypsum from mirabilite and limestone by a PCET reaction according to the present disclosure will be further described with reference to specific examples.

### Example 1

The process for preparing soda ash and co-producing high-purity gypsum from mirabilite and limestone by a PCET reaction in the example comprises the steps of:

placing the cation exchange membrane into an electrolytic cell to divide the electrolytic cell into an anode region and a cathode region, adding 50 mL of sodium acetate solution (with the concentration of 2 M) into the anode region as an anolyte, adding 50 mL of sodium carbonate (with the concentration of 3 M) into the cathode region, simultaneously bubbling CO₂ gas at the rate of 10 mL/min in the cathode region for 5 minutes, and continuously circulating the electrolyte into an electrode compartment of the electrolytic cell by a peristaltic pump at the flow rate of 20 mL/min; adding 0.3 mol/L

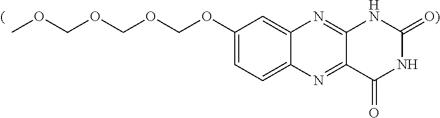

into the cathode region as cathode electrocatalyst M, adding 0.3 mol/L reduction-state

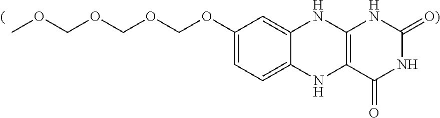

into the anode region as the anode electrocatalyst MH, and applying a DC source (IT6932A, Itech) between the anode and cathode electrodes to provide current.

Wherein, the anode electrode is graphite felt, the cathode electrode is graphite felt, the electrolysis voltage is 1.02 V, the current density is 55.6 mA/cm², and the electrolysis reaction temperature is at 40° C. for 1 hour.

Under the action of electric current, Na₂CO₃ is continuously generated in the cathode region, and acetic acid is continuously generated in the anode region. According to the acid-base titration, the alkalinity of catholyte is increased by 0.22 mol/L, the acidity of anolyte is increased by 0.22 mol/L, and the current efficiency reaches 98.3%. At the same time, the

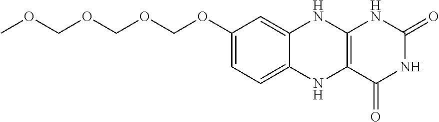 [SMILES: COCOCOCOc1ccc2c(c1)Nc1[nH]c(=O)[nH]c(=O)c1N2]

in the anode region is converted into

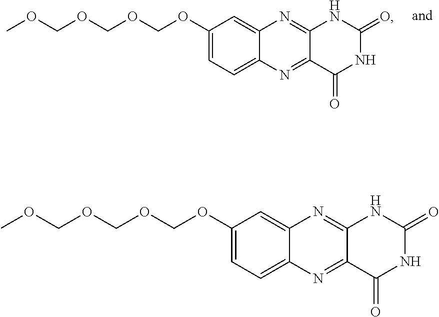 [SMILES: COCOCOCOc1ccc2nc3c(=O)[nH]c(=O)[nH]c3nc2c1 ; COCOCOCOc1ccc2nc3c(=O)[nH]c(=O)[nH]c3nc2c1]

in the cathode region is converted into

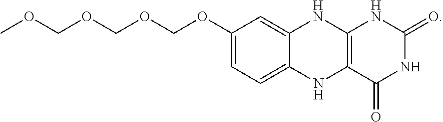 [SMILES: COCOCOCOc1ccc2c(c1)Nc1[nH]c(=O)[nH]c(=O)c1N2]

After the electrolysis reaction is finished, the organic electro-mechanical catalyst in the electrolyte is intercepted by the nanofiltration membrane, and the solution passing through the nanofiltration membrane is an inorganic salt solution completely free of the electrocatalyst.

Next, mixing the anolyte containing 0.22 mol/L of acetic acid with 0.9 g of limestone and reacting at 300 rpm for 3 hours, with the conversion rate of acetic acid calculated to 94.7% by acid-base titration; after mixing the reacted solution with 30 mL of 1 mol/L Na₂SO₄ solution and stirring at 300 rpm for 40 min, and measuring the concentration of calcium ions in the solution to indicate the conversion rate at which Ca²⁺ precipitates to CaSO₄ at this time reaches 91.27%; and performing suction filtration on the obtained solid, and drying it at 60° C. for 6 hours to obtain a calcium sulfate solid product. The XRD results of the calcium sulfate product are shown in FIG. 5. As can be seen from FIG. 5, the product dried at 60° C. is calcium sulfate hemihydrate without impurities, and the characteristic peaks of other substances are not detected. In combination with further chemical titration results, the purity of the product calcium sulfate is up to 99.4%, and waste gypsum (CaSO₄) containing various impurities such as phosphorus, fluorine and the like is not obtained like phosphorus chemical production, and the gypsum produced in the example can be used as a building materials, ceramic materials and sculpture materials, at least solid stacks harmless to the environment.

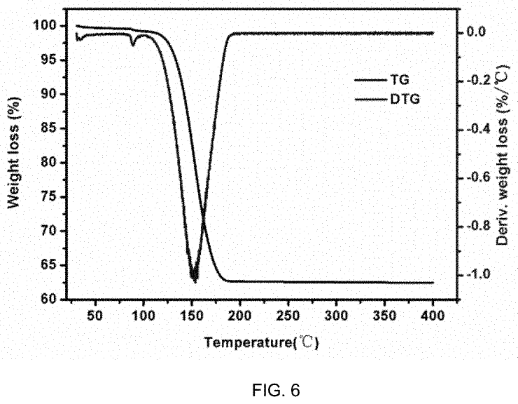

The sodium carbonate solution in the cathode region is placed into a rotary evaporator and treated under vacuum at 80° C. for 6 hours to give a solid sodium carbonate product, the thermogravimetric analysis results of which are shown in FIG. 6. Examination by the thermogravimetric analyzer (TGA) shows that the purity of sodium carbonate obtained in this example is up to 99.7%.

The energy consumption (W) of electrolysis is related to voltage (V) and current efficiency (η):

$$W = \frac{U \times {10}^{3}}{q \times η} \times m$$

where U is electrolysis voltage, η is current efficiency, m is weight of Na₂CO₃ produced, q is electrochemical equivalent, and q=1.977 g/(A·h) when Na₂CO₃ is produced.

Taking the example as a calculation standard, the electrolysis voltage is 1.02 V, the current efficiency is calculated to be 98.3% in the example, the electrolysis energy consumption per ton of soda ash (Na₂CO₃) is 614 kW·h, and the production energy consumption of the soda ash solution is about 7.25 GJ/t. Compared with the traditional ammonia-soda process (the energy consumption is about 15 GJ/t), the energy consumption of the present disclosure has obvious advantages

### Example 2

The process for preparing soda ash and co-producing high-purity gypsum from mirabilite and limestone by a PCET reaction in the example comprises the steps of:

placing a cation exchange membrane into an electrolytic cell to divide the electrolytic cell into an anode region and a cathode region, adding 50 mL of sodium formate solution (with the concentration of 3 M) into the anode region as an anolyte, adding 50 mL of sodium carbonate (with the concentration of 2 M) into the cathode region, simultaneously bubbling CO₂ gas at the rate of 20 mL/min in the cathode region, and continuously circulating the electrolyte into an electrode compartment of the electrolytic cell by a peristaltic pump at the flow rate of 20 mL/min; meanwhile, adding 0.1 mol/L

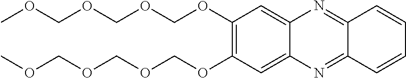 [SMILES: COCOCOCOc1cc2nc3ccccc3nc2cc1OCOCOCOC]

into the cathode region as cathode electrocatalyst M, adding 0.1 mol/L

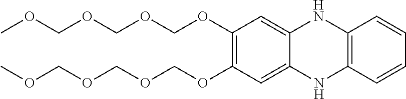 [SMILES: COCOCOCOc1cc2c(cc1OCOCOCOC)Nc1ccccc1N2]

into the anode region as anode electrocatalyst MH, and applying a DC power supply (IT6932A, Itech) between the anode electrode and the cathode electrode to provide a current.

Wherein, the anode electrode is a carbon felt, the cathode electrode is a carbon felt, the electrolysis voltage is 0.53V, the current density is 55.6 mA/cm², the electrolysis reaction temperature is 60° C., and the electrolysis reaction is performed for 10 hours; during the electrolysis process, introducing the anolyte into 20 mL of chloroform solution at intervals to be mixed, so that part of the electrocatalyst M in the anolyte enters the chloroform phase; then mixing the chloroform solution rich in M with the catholyte, such that part of the electrocatalyst M in chloroform enters the catholyte while the MH in the catholyte enters the chloroform solution to be mixed with the anolyte again, and the MH is transferred to the anolyte, thereby achieving “extraction-reverse extraction” of the catholyte and anolyte, thus maintaining a continuous and stable progress of the electrolysis reaction.

Under the action of electric current, Na₂CO₃ is continuously generated in the cathode region, and formic acid is continuously generated in the anode region. According to the acid-base titration, the alkalinity of catholyte is increased by 2.16 mol/L, the concentration of sodium carbonate reaches 24.7%, the acidity of anolyte is increased by 2.16 mol/L, and the current efficiency reaches 96.5%. After the electrolysis reaction is finished, respectively extracting the anolyte and catholyte with 200 mL of dichloromethane by using an extraction tower, and extracting the electrocatalyst into an organic phase.

Next, mixing the anolyte containing 2.16 mol/L formic acid with 9 g of limestone and reacting at 300 rpm for 3 hours, with the conversion rate of formic acid calculated to 97.6% by acid-base titration; after mixing the reacted solution with 300 mL of 1 mol/L Na₂SO₄ solution and stirring at 300 rpm for 40 min, and measuring the concentration of calcium ions in the solution to indicate the conversion rate at which Ca²⁺ precipitates to CaSO₄ at this time reaches 92.13%; performing suction filtration on the obtained solid, and drying it at 60° C. for 6 hours to obtain 8.28 g of calcium sulfate solid product with the purity up to 99.3% and the conversion rate of the finally obtained calcium sulfate being 89.36%.

The sodium carbonate solution with increased concentration obtained in the cathode region is placed in a rotary evaporator and treated under 80° C. vacuum for 3 hours to obtain 15.687 g of anhydrous sodium carbonate solid with purity up to 99.7%. The conversion rate of anhydrous sodium carbonate obtained in the cathode region is calculated up to 96.1%.

The energy consumption (W) of electrolysis is related to voltage (V) and current efficiency (η):

$$W = \frac{U \times {10}^{3}}{q \times η} \times m$$

where U is electrolysis voltage, η is current efficiency, m is weight of Na₂CO₃ produced, q is electrochemical equivalent, and q=1.977 g/(A·h) when NaOH is produced.

Taking the example as a calculation standard, the electrolysis voltage is 0.53 V, the current efficiency is calculated to be the average current efficiency 96.5% in the example, the electrolysis energy consumption for producing per ton of 24.7% soda ash solution (Na₂CO₃) is 312.7 kW·h, which is converted into an equivalent heating value that the production energy consumption of the soda ash solution is about 3.70 GJ/t. Compared with the traditional ammonia-soda process (energy consumption is about 15 GJ/t), the manufacturing energy consumption of soda ash can be greatly reduced by more than 70% by utilizing the technology provided by the present disclosure and in combination with the PCET electrocatalyst with high activity and good solubility, which shows obvious energy consumption advantages and the possibility of commercial popularization and application.

The data from Examples 1 and 2 show that there are a large number of substances capable of generating the PCET reaction, the electrolysis effect and the electrolysis energy consumption of different substances served as electrocatalysts are different, the effects of reducing the energy consumption and saving the cost of each substance with the PCET reaction characteristic in the present disclosure are also different, and the electrocatalyst with high solubility, good stability and good electrochemical activity is preferred, so as to maximize the energy consumption and the cost advantages of the process technology of the present disclosure.

### Example 3

The process for preparing caustic soda and coproducing high-purity gypsum from mirabilite and limestone by a PCET reaction in the example comprises the steps of:

placing a cation exchange membrane into an electrolytic cell to divide the electrolytic cell into an anode region and a cathode region, adding 50 mL of sodium formate solution (with the concentration of 1.5 mol/L) to the anode region as an anolyte, adding 50 mL of sodium hydroxide (with the concentration of 1.5 mol/L) to the cathode region, and continuously circulating the electrolyte into an electrode compartment of the electrolytic cell by a peristaltic pump at the flow rate of 20 mL/min; meanwhile, adding 0.3 mol/L

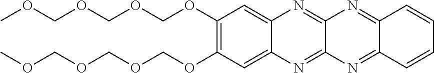 [SMILES: COCOCOCOc1cc2nc3nc4ccccc4nc3nc2cc1OCOCOCOC]

into the cathode region as cathode electrocatalyst M, adding 0.3 mol/L

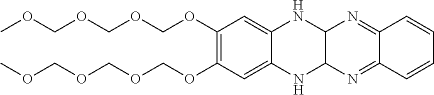 [SMILES: COCOCOCOc1cc2c(cc1OCOCOCOC)NC1N=c3ccccc3=NC1N2]

into the anode region as anode electrocatalyst MH, and applying a DC power supply (IT6932A, Itech) between the anode electrode and the cathode electrode to supply current;

where the anode electrode is carbon cloth, the cathode electrode is carbon cloth, the current density is 55.6 mA/cm², the average electrolysis voltage is 1.07 V under the condition that the electrolysis reaction temperature is 40° C., and the electrolysis reaction is performed for 5 hours. During the electrolysis process, introducing the anolyte into 20 mL of chloroform solution for mixing, so that part of the electrocatalyst M in the anolyte enters the chloroform phase, and then mixing the chloroform solution rich in M with the catholyte, so that part of the electrocatalyst M in chloroform enters the catholyte while MH in the catholyte enters the chloroform solution to be mixed with the anolyte again, and the MH is transferred into the anolyte, thereby achieving the “extraction-reverse extraction” of the catholyte and anolyte, thus maintaining the continuous and stable progress of the electrolysis reaction.

Under the action of current, NaOH is continuously generated in the cathode region, and formic acid is continuously generated in the anode region. According to the acid-base titration, the alkalinity of catholyte is increased by 1.01 mol/L, the current efficiency is 90.17%, the acidity of anolyte is increased by 1.02 mol/L, and the current efficiency is 91.1% when NaOH is produced, because the OH⁻ moiety in the catholyte would penetrate through the ion-exchange membrane to reach the anode region, resulting the current efficiency is lower than that of the ending of the electrolysis reaction of Na₂CO₃ production; respectively extracting the anolyte and catholyte with dichloromethane by using an extraction column, and extracting the electrocatalyst into the organic dichloromethane phase.

Next, mixing the anolyte containing 1.02 mol/L of formic acid with 4.5 g of limestone and reacting at 800 rpm for 5 hours, with the conversion rate of formic acid calculated to 98.2% by acid-base titration; after mixing the reacted solution with 150 mL of 1 mol/L Na₂SO₄ solution and stirring at 800 rpm for 60 min, and measuring the concentration of calcium ions in the solution to indicate the conversion rate at which Ca²⁺ precipitates to CaSO₄ at this time reaches 93.16%; and performing suction filtration on the obtained solid, drying it at 60° C. for 6 hours to obtain 4.32 g of a calcium sulfate solid product with the purity up to 99.2% and the conversion rate of the finally obtained calcium sulfate being 90.13%.

The concentration of NaOH solution obtained in the final cathode region is 2.52 mol/L.

The energy consumption (W) of electrolysis is related to voltage (V) and current efficiency (η):

$$W = \frac{U \times {10}^{3}}{q \times η} \times m$$

where U is electrolysis voltage, η is current efficiency, m is weight of Na₂CO₃ produced, q is electrochemical equivalent, and q=1.492 g/(A·h) when NaOH is produced.

Taking the example as a calculation standard, the average electrolysis voltage is 1.07 V, the current efficiency is 90%, the electrolysis energy consumption per ton of caustic soda is 800 kW·h, the traditional ionic membrane electrolysis technology needs at least about 2.9 V electrolysis voltage, and the electrolysis energy consumption per ton of caustic soda is 2,200 kW·h. Therefore, the method has very low energy consumption, with the possibility of commercial popularization and application.

### Example 4

The process for preparing caustic soda and coproducing high-purity gypsum from mirabilite and limestone by a PCET reaction in the example comprises the steps of: placing a cation exchange membrane into an electrolytic cell to divide the electrolytic cell into an anode region and a cathode region, adding 50 mL of sodium formate solution (with the concentration of 1.5 M) to the anode region as an anolyte, adding 50 mL of sodium hydroxide (with the concentration of 2 M) to the cathode region, continuously circulating the electrolyte into an electrode compartment of the electrolytic cell by a peristaltic pump at the flow rate of 20 mL/min, and adding 0.3 mol/L

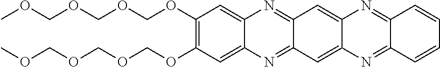 [SMILES: COCOCOCOc1cc2nc3cc4nc5ccccc5nc4cc3nc2cc1OCOCOCOC]

into the cathode region as cathode electrocatalyst M, adding 0.3 mol/L

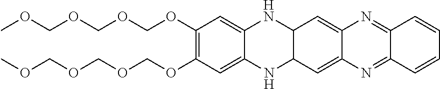 [SMILES: COCOCOCOc1cc2c(cc1OCOCOCOC)NC1C=c3nc4ccccc4nc3=CC1N2]

into the anode region as anode electrocatalyst MH, and applying a DC power supply (IT6932A, Itech) between the anode and cathode electrodes to provide current.

Wherein, the anode electrode is carbon cloth, the cathode electrode is carbon cloth, the current density is 55.6 mA/cm², the electrolysis reaction temperature is 60° C., the electrolysis reaction time is 5 hours, the average voltage is 1.0 V, the electrolysis efficiency is 92%, and the electrolysis energy consumption per ton of caustic soda is 729 kW·h. During the electrolysis process, introducing the anolyte into 20 mL of chloroform solution at intervals to be mixed, so that part of the electrocatalyst M in the anolyte enters the chloroform phase, and then the chloroform solution rich in M is mixed with the catholyte, so that part of the electrocatalyst M in the chloroform enters the catholyte while MH in the catholyte enters the chloroform solution to be mixed with the anolyte again, and MH is transferred to the anolyte, thereby achieving the “extraction-reverse extraction” of the catholyte and anolyte, thus maintaining the continuous and stable progress of the electrolysis reaction. After the electrolysis reaction is finished, respectively extracting the anolyte and the catholyte with 200 mL of dichloromethane, and extracting the electrocatalyst into an organic phase.

The electrolysis voltage of the sodium hydroxide prepared by the method is reduced from 2.9 V of the traditional electrolysis method to about 1V, the electrolysis energy consumption is greatly reduced from 2245 kWh per ton of NaOH to about 800 kWh per ton of NaOH, and the method has the potential of industrial popularization.

The above is only the preferred example of the present disclosure, and is not intended to limit the present disclosure. Any modifications, equivalent substitutions and improvements made within the spirit and principles of the present disclosure should be included in the protection of the present disclosure.

What is claimed is:

1. A method for preparing an alkali, comprising steps of:
performing cation membrane exchange, wherein an anode region comprises weak acid radical ions and a compound MH capable of performing PCET reaction, a cathode region comprises a compound M capable of performing PCET reaction, the anode region and the cathode region comprise sodium ions, and a pH value of the cathode region is higher than a pH value of the anode region; and
applying a DC power supply between an anode electrode and a cathode electrode.

2. The method of claim 1, wherein,
the alkali is soda ash, and when in performing said cation membrane exchange, the anode region comprises a solution of a sodium salt of a weak acid and a compound MH capable of performing PCET reaction, the cathode region comprises sodium carbonate and a compound M capable of performing PCET reaction, and the method further comprises introducing CO₂ into the cathode region; or
the alkali is caustic soda, and when in performing said cation membrane exchange, the anode region comprises a solution of sodium salt of a weak acid and a compound MH capable of performing PCET reaction, and the cathode region comprises sodium hydroxide and a compound M capable of performing PCET reaction;
preferably, the cation membrane exchange is performed by placing a cation exchange membrane into an electrolytic cell divided into the anode region and the cathode region.

3. A method for preparing gypsum, comprising:
reacting a liquid in an anode region obtained after the alkali preparation in claim 1 with limestone;
performing mirabilite dissolving; and
mixing the solution obtained from the mirabilite dissolving with the solution obtained by said reacting with the limestone.

4. A method for preparing an alkali and gypsum, the method comprising:
preparing the alkali, comprising:
performing cation membrane exchange, wherein an anode region comprises weak acid radical ions and a compound MH capable of performing PCET reaction, a cathode region comprises a compound M capable of performing PCET reaction, the anode region and the cathode region comprise sodium ions, and a pH value of the cathode region is higher than a pH value of the anode region; and
applying a DC power supply between an anode electrode and a cathode electrode; and
preparing the gypsum, comprising:
reacting the liquid obtained from the anode region with limestone;
performing mirabilite dissolving; and
mixing the solution obtained from the mirabilite dissolving with the solution obtained by said reacting with the limestone;
preferably, the alkali is soda ash or caustic soda.

5. The method of claim 3, wherein said mirabilite dissolving is performed by introducing mirabilite into a salt dissolving tank for dissolving to form a sodium sulfate solution.

6. The method of claim 3, wherein said reacting with the limestone is performed by simultaneously introducing the limestone and the liquid in the anode region into a dissolving agitator;
preferably, said reacting with the limestone generates CO₂;
preferably, the CO₂ is subjected to washing and compression procedures after being generated; and
preferably, the CO₂ is circulated to the cathode region for a soda ash production.

7. The method of claim 3, wherein said mixing comprises:
simultaneously introducing the solution obtained by reaction with limestone and the solution obtained from said mirabilite dissolving into a precipitation reactor to generate precipitates in the precipitation reactor; and
performing solid-liquid separation on the precipitates and the solution in the precipitation reactor;
preferably, a solution performing said solid-liquid separation is refined by brine and then introduced into an electrolytic cell, and the precipitates are dried to remove water;
preferably, a solution after performing said solid-liquid separation is a solution of a sodium salt of a weak acid;
preferably, the precipitates are solid precipitates of calcium sulfate.

8. The method of claim 2, wherein the alkali is sodium carbonate, and after said applying the DC power supply, the method further comprises:
evaporating and crystallizing a liquid in the cathode region;
calcining monohydrate sodium carbonate; and
cooling the alkali.

9. The method of claim 2, wherein the alkali is a solid caustic soda flake, and after the applying a DC power supply, the method further comprises:
evaporating a liquid in the cathode region.

10. The method of claim 2, wherein the sodium salt of the weak acid is selected from the group consisting of sodium acetate, sodium formate, sodium oxalate, sodium citrate, sodium borate, and sodium lactate.

11. The method of claim 1, wherein the compound M is an aromatic compound or a compound with free radicals.

12. The method of claim 11, wherein the compound M is an aromatic compound comprising a carbonyl group or a heterocycle;
preferably, the carbon atom of the carbonyl group is positioned on the aromatic ring of the aromatic compound; or
preferably, the heteroatom of the heterocycle is nitrogen; or
preferably, the compound comprises a plurality of heterocycles.

13. The method of claim 11, wherein the compound M is a fused ring compound comprising at least a structure of Formula (A), 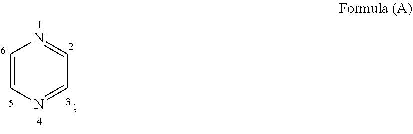
preferably, carbon atoms at positions 2 and 3 in the structure of Formula (A) are forming a common edge of the structure of Formula (A) and another aromatic ring;
preferably, the fused ring comprises at least a structure of Formula (B), 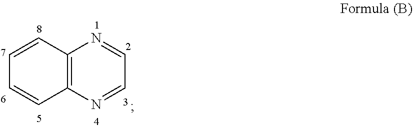
preferably, carbon atoms at positions 2 and 3 in the structure of Formula (B) are forming a common edge of the structure of Formula (B) and another aromatic ring;
preferably, the fused ring comprises at least two structures of Formula (B);
preferably, carbon atoms at positions 2 and 3 in the two structures of the Formula (B) are forming a common edge of the two structures of the Formula (B), or common edges of the two structures of the Formula (B) and another aromatic ring respectively;
preferably, the fused ring comprises at least a structure of Formula (C) or a structure of Formula (D),

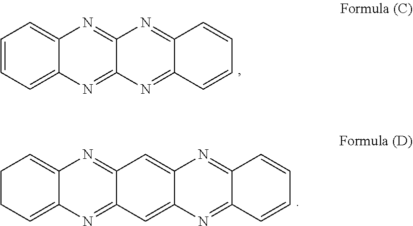 [SMILES: c1ccc2nc3nc4ccccc4nc3nc2c1 ; C1=c2nc3cc4nc5ccccc5nc4cc3nc2=CCC1]

14. The method of claim 12, wherein the compound M comprises at least a structure of Formula (E), 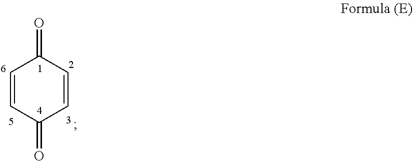
preferably, carbon atoms at positions 2 and 3 in the structure of Formula (E) are forming a common edge of the structure of Formula (E) and another aromatic ring; and
preferably, carbon atoms at positions 2 and 3 in the structure of Formula (E) are forming a common edge of the structure of Formula (E) and the another aromatic ring, and carbon atoms at positions 5 and 6 in the structure of Formula (E) are forming a common edge of the structure of Formula (E) and yet another aromatic ring.

15. The method of claim 11, wherein the compound M comprises at least a structure of Formula (F), 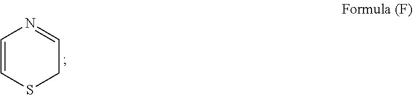
preferably, the compound M is a fused ring compound, and the aromatic ring is a part of a fused ring;
preferably, the compound M comprises at least Formula (G),

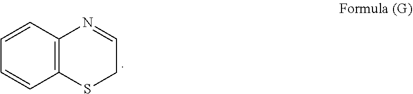

16. The method of claim 1, wherein the structural formula of compound M is selected from the group consisting of compounds of following structural formula 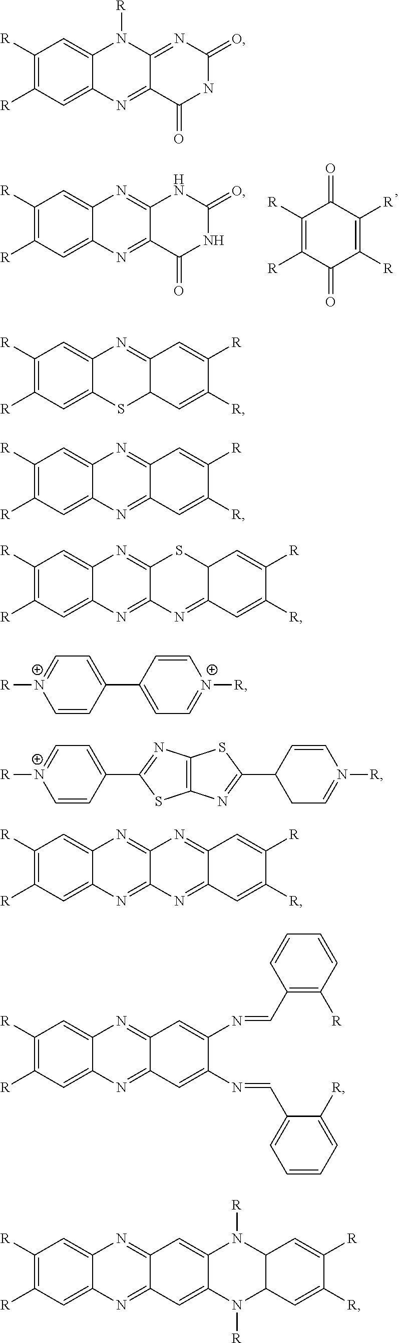 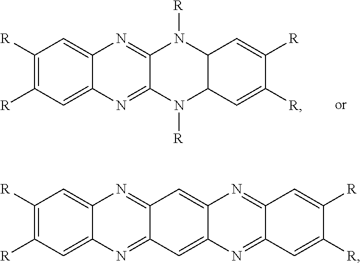
wherein any R is independently selected from H, methyl, ethyl, hydroxy, sulfonic group, carboxylic group, PEG group, imidazolyl, amino, chlorine, or bromine.

17. The method of claim 1, further comprising performing extraction-reverse extraction or entrapment treatment after the cation membrane exchange;
preferably, the extraction-reverse extraction is performed with an organic solvent;
preferably, the organic solvent is selected from the group consisting of dichloromethane, chloroform, carbon tetrachloride, ethyl acetate, kerosene, ionic liquid methylimidazolium hexafluorophosphate, trioctylphosphine oxide or petroleum ether; and
preferably, the interception treatment is an interception treatment by a dialysis membrane and/or a nanofiltration membrane.

18. The method of claim 1, wherein the anode electrode and/or the cathode electrode is a carbon material electrode, or a porous electrode or a three-dimensional structured electrode made of a carbon material;
preferably, the carbon material electrode is one or more of, graphite felt, carbon felt, carbon paper, and carbon cloth, or one or more of graphite felt, carbon felt, carbon paper, and carbon cloth doped with an active material.

19. The method of claim 3, wherein the molar ratio of an added amount of the limestone to the sodium salt of the weak acid is 1:2-1:0.5.

20. The method of claim 7, further comprising washing and drying the precipitates at 50-150° C. to remove water, preferably oven drying at 100-150° C. to remove water.
